(19) United States
(12) Patent Application Publication
(10) Pub. No.: US 2004/0140350 A1
(43) Pub. Date: Jul. 22, 2004

(54) Wall-mounted touch screen information system

(76) Inventors: Anthony Valencia, Santa Rosa, CA (US); Mary Justin, Santa Rosa, CA (US)

Correspondence Address: JOHNSON & STAINBROOK, LLP, Ste. 203, 3550 Round Barn Blvd., Santa Rosa, CA, 95403, US

(21) Appl. No.: 10/756,067

(22) Filed: Jan. 13, 2004

Related U.S. Application Data
(63) Continuation-in-part of application No. 10/062,372, filed on Jan. 31, 2002, now Pat. No. 6,688,518.

(51) Int. Cl. G06F 17/00

(52) U.S. Cl. 235/375

(57) ABSTRACT

A wall-mounted touch screen information system is comprised of a rugged housing with a hinged front cover. The housing is compact enough for wall mounting. A single board computer inside the housing is connected to a touch screen and a CCD camera. Network connection means are provided for network communications. A CD drive connected to the single board computer enables different software to be installed for performing a variety of communication, information retrieval, and financial functions. All the external components of the system are made of materials strong enough to withstand abuse and vandalism.

### CROSS REFERENCE TO RELATED APPLICATIONS

The present application is a continuation-in-part of U.S. Utility patent application Ser. No. 10/062,372, filed Jan. 31, 2002.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to software driven touch screen information systems, more particularly to a wall-mounted touch screen information system adapted for use in libraries by predetermined authorized users.

### BACKGROUND INFORMATION AND DISCUSSION OF RELATED ART

Kiosks are commonly used for providing a variety of services, including financial, telephone, and information services. The most common type of kiosk is the ATM, which is a large, expensive, and immobile machine. An example of an ATM is disclosed in U.S. Pat. No. 4,179,723 to Spencer. Although smaller kiosks are disclosed in U.S. Pat. No. 6,118,860 to Hillson et al.; U.S. Pat. No. 5,732,398 to Tagawa; U.S. Pat. No. 4,902,881 to Janku; and U.S. Pat. No. 4,247,759 to Yuris et al., they are still quite large and expensive. Other kiosks disclosed in U.S. Pat. No. 6,078,848 to Bernstein et al. and U.S. Pat. No. 5,602,905 to Mettke are comprised of conventional personal computers inside specially designed cabinets. Suitable locations for installation of the smaller conventional kiosks are limited because they are still relatively large and cumbersome. Also, their conventional keyboards and mice input devices are too fragile for environments where they may be subject to abuse and vandalism. Further, a typical kiosk is dedicated to performing a single function, such as dispensing cash, providing Internet access, etc. The market for a dedicated kiosk is thus limited.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is a touch screen information system comprising a rugged housing with a hinged front cover. The housing is compact enough for installation on a wall or any permanent apparatus having a suitably sturdy flat or inclined surface, such as a table top, desktop, rolling cart, and the like. A single board computer inside the housing is connected to a touch screen and CCD camera. Optionally, a card reader and a spool printer may be attached to the front cover. As another option, a telephone handset is supported in a cradle attached to the side of the housing. The handset is connected to audio ports on the single board computer by an armored cable. Network connection means, including preferably a modem and Ethernet, are provided on the single board computer for voice and network communications. A CD drive connected to the single board computer enables different software to be installed for performing a variety of communication, information retrieval, and financial functions. All the external components of the system are made of materials strong enough to withstand abuse and vandalism.

It is therefore an object of the present invention is to provide a new and improved wall-mounted touch screen information system small enough for wall mounting at a variety of locations.

It is yet a further object of the present invention is to provide a wall-mounted touch screen information system durable and rugged enough to resist abuse and vandalism.

It is still another object of the present invention is to provide a touch screen with audio feedback.

Another object of the present invention is to provide a wall-mounted touch screen information system to enable voice communication with a remote party.

Yet another object of the present invention is to provide a wall-mounted touch screen information system that enables Internet browsing.

A still further object of the present invention is to provide a wall-mounted touch screen information system that provide means for making payment for services.

Yet another object of the present invention is to provide a wall-mounted touch screen information system capable of recording an image of the user and to upload the image to a server.

Further still, and yet another object of the present invention, is to provide a wall-mounted touch screen information system that prints a receipt for transactions.

Finally, it is an object of the present invention to provide a wall-mounted touch screen information system that may be easily installed with different software for performing different functions.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a front-left perspective view of the present wall-mounted touch screen information system;

FIG. 2 is a front-right perspective view thereof;

FIG. 3 is a right-rear perspective view thereof;

FIG. 4 is a front-right perspective view thereof with the housing opened;

FIG. 5 is a block diagram showing the functional components of the single board computer employed in the inventive apparatus;

FIG. 6 is a diagram showing the functional elements of the inventive apparatus;

FIG. 7 is a flowchart showing an exemplar of the function of the inventive apparatus; and

FIG. 8 shows a simplified, second preferred, embodiment of the present invention.

### DRAWING REFERENCE NUMERALS

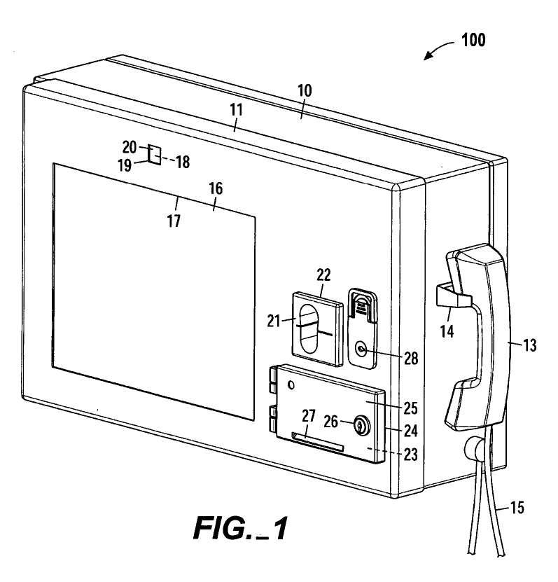

FIGS. 1-8

10. Housing 11. Front Cover

12. Hinges 13. Handset

14. Cradle 15. Armored Cable

16. Touch Screen 17. Opening

18. Camera 19. Opening

20. One-Way Mirror 21. Card Reader

22. Opening 23. Printer

24. Opening 25. Cover

26. Lock 27. Slot

28. Lock 29. Rear Surface

30. Stud 31. Hole

32. Notch 33. Conduit

34. Cable Opening 35. Ventilation Hole

36. Single Board Computer 37. Memory

38. Floppy Drive 39. Hard Disk

40. CD Drive 41. Fan

42. Power Supply 43. Power Switch

44. Ventilation Slots 45. Bottom

46. LCD Panel 47. Touch Panel

48. CPU 49. Video

50. Ethernet 51. IDE

52. Audio 53. Modem

54. Keyboard Port 55. Mouse Port

56. USB Ports 57. Parallel Port

58. Microphone In 59. Speaker Out

60. Corn Ports 61. Speaker

70-86. Flowchart Blocks

### DETAILED DESCRIPTION OF THE INVENTION

Referring to FIGS. 1 through 8, wherein like reference numerals refer to like components in the various views, there is illustrated therein a new and improved wall-mounted touch screen information system.

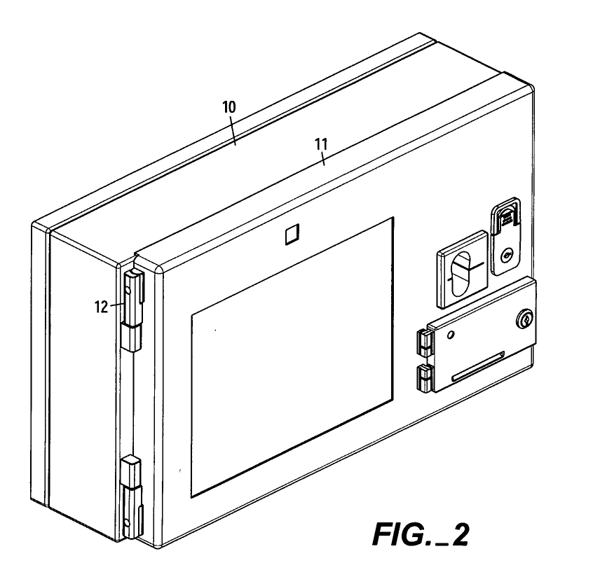

A first preferred embodiment of the present wall-mounted touch screen information system, generally denominated 100, is shown in front perspective views in FIGS. 1 and 2. It comprises a substantially cuboid housing 10, rectangular on each side, and is preferably fabricated from a strong sheet metal. Housing 10 is preferably about 23 inches wide by about 14 inches tall, compact enough for mounting in a great variety of locations while large enough to provide an appropriately sized and practically usable viewing screen. A front cover 11 is hingedly affixed to housing 10 by tamper resistant hinges 12 (FIG. 2), preferably on the side opposite that of an optional telephone handset 13, the latter which may be supported in a cradle 14 attached to a side of housing 10. Handset 13 is comprised of a rugged handset of the type used on payphones, and is connected to housing 10 by an armored cable 15.

A touch screen 16 is installed within and behind a rectangular opening 17 in front cover 10. A CCD camera 18 is installed behind a smaller rectangular 19 opening in the front cover, and behind a dark one-way mirror 20 to avoid easy detection. A card reader 21 is installed in an opening 22 in front cover 10. An optional spool printer 23 may be installed behind an opening 24 in front cover 10. The front of printer 23 is covered by a tamper resistant metal printer cover 25, which is hinged to the surface of front cover 10 and secured by a printer cover lock 26. A slot 27 on printer cover 25 is arranged for dispensing printed receipts. A front cover lock 28 is attached to front cover 11 for securing it to housing 10. There is no externally accessible power switch, mechanical keyboard, pointing device, or mechanical telephone keypad.

All of the external components of the system are made of materials strong enough to resist abuse and vandalism. Therefore, the system is suitable for installation in unfriendly environments such as arraignment facilities in police departments, jails, prisons, juvenile detention facilities, public parks and beaches, public transportation kiosks, as well as any other environment which allows even only short periods of unsupervised access to the system.

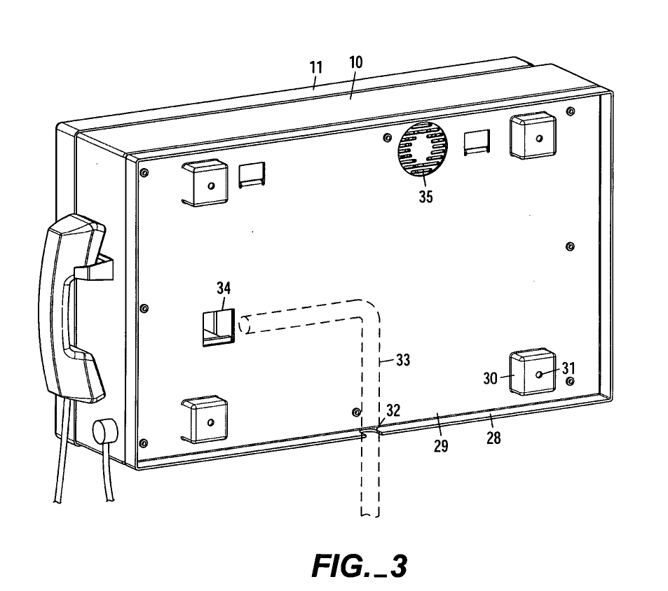

The inventive system is shown in a rear view in FIG. 3. A rearward projecting lip 28 is arranged around the rear perimeter of housing 10 to space a rear surface 29 of housing 10 from the mounting wall. Rearward projecting studs 30 are arranged on rear surface 29 of housing 10. The rear surfaces of studs 30 are coplanar with the rear edge of lip 29. Holes 31 on studs 30 allow mounting screws or bolts to be inserted from the inside of housing 10 and into a wall, so that the screws or bolts are protected from tampering when cover 11 is closed and locked. A notch 32 on lip 28 at the bottom of housing 10 enables the passage of an electrical conduit 33 mounted on the surface of the wall. Power and communication cables that emerge from electrical conduit 33 are threaded through a cable opening 34 on rear surface 29 of housing 10. Electrical cables which emerge from the wall without the conduit can be threaded through cable opening 34 without being passed through notch 32. A fan ventilation hole 35 is arranged on rear surface 29 of housing 10.

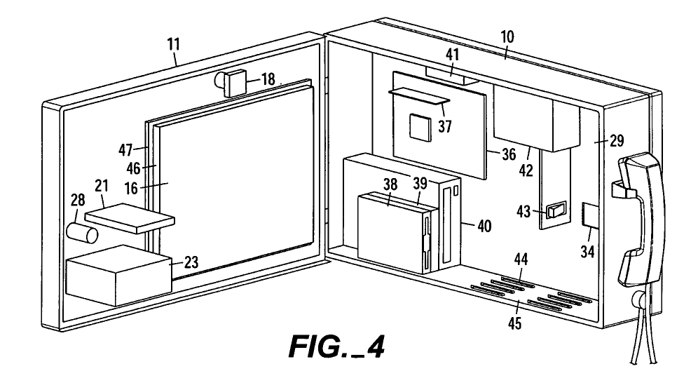

The system is shown with cover 11 opened in a front-right perspective view in FIG. 4. A single board computer 36 is attached inside housing 10. The single board computer comprises a highly integrated circuit board with many built-in features typically provided by add-on boards in desktop personal computers. Single board computer 36 preferably has an EBX form factor, which is only about 5.75 inch×8 inch. It is thus much more compact than a conventional personal computer motherboard with orthogonal expansion cards. The only necessary orthogonal card on single board computer 36 is a small memory module 37.

In addition to single board computer 36, a floppy drive 38, a hard disk 39, a CD drive 40, a fan 41, a power supply 42, and a power switch 43 are attached inside housing 10. Cable opening 34 is positioned through the back of housing 10, and ventilation holes 44 are positioned through bottom surface 45 of housing 10. Ventilation holes are of a small size for minimizing RF interference, and are preferably on the bottom of housing 10 to minimize dust intrusion and resist vandalism. Power switch 43 is connected between power supply 42 and the AC power cable from cable opening 34. Power switch 43 is left on when cover 11 is closed.

Touch screen 16 is attached to the rear (interior) surface of hinged cover 11. The touch screen comprises a color LCD panel 46 positioned behind a transparent touch panel 47. LCD panel 46 preferably comprises a 15 inch TFT screen with 1024×768 resolution, or similarly high resolution. Touch panel 47 preferably comprises the INTELLITOUCH® system sold by Elo Touch Systems, Inc., of Fremont, Calif., with a 0.25 inch SECURETOUCH® glass panel with is strong enough to resist abuse. Further, the glass panel is preferably treated with the PANEL-GUARD process by Reptron Electronics, Inc., of Tampa, Fla., to avoid fragmentation if broken.

Color CCD camera 18 with composite video output is installed within housing 10 and attached to the rear (interior) surface of cover 11. Camera 18 is preferably centered above touch screen 16 for a direct view of the user standing before the screen. Card reader 21 is installed withing housing 10 and attached to the rear surface of cover 11 proximate and laterally adjacent to touch screen 16. Card reader 21 preferably comprises a combined magnetic card and smart card reader capable of reading magnetic strip cards, such as credit cards, ATM cards, and driver's licenses, and also capable of reading smart cards with embedded microprocessors.

An optional printer 23 is attached to the rear surface of cover 11 for printing receipts. Printer 23 is preferably encased in a hard polycarbonate case for durability, and is preferably a dot matrix printer for flexibility in producing different fonts, including fonts in different languages, and for producing graphics. Lock 28 is positioned through cover 11 adjacent card reader 21.

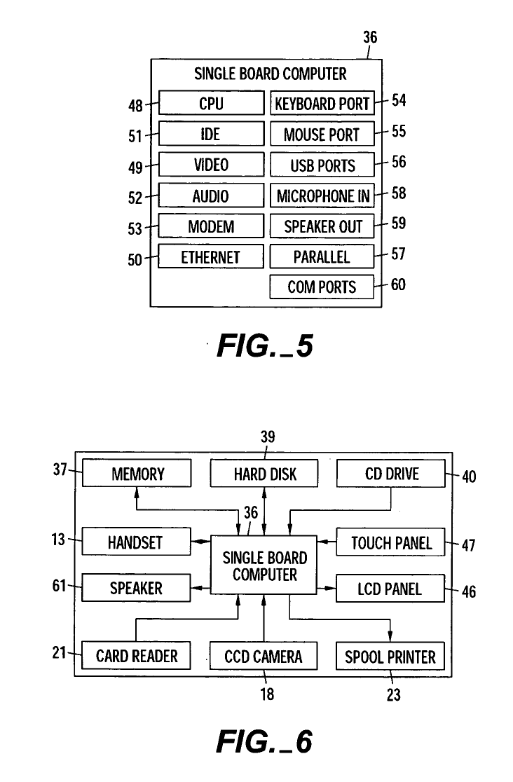

A block diagram of single board computer 36 is shown in FIG. 5. The single board computer preferably comprises an EBX form factor board that supports PC/104 and PC/104-Plus module expansion, such as the model PCM-9550F/FM computer by Advantech Co. Ltd., of Düsseldorf, Germany. Integrated features on single board computer 36 include a CPU 48 which is preferably an Intel PENTIUM® operating at 266 MHz, a PCI video controller 49 capable of driving the LCD at its native resolution, a PC 10/100Base-T Ethernet interface 50, an IDE controller 51, an audio controller 52, a full-duplex fax/modem 53, a keyboard port 54, a mouse port 55, USB ports 56, a parallel port 57, a microphone-in connector 58, speaker-out connector 59, and com ports 60. Single board computer 36 also includes a memory slot for attaching a RAM module, and preferably a PC/104-Plus expansion slot for adding an expansion board. All the ports and slots are integrated on single board computer, and are not accessible when the front cover is closed.

The modem is for connecting to a telephone line for fax and modem communications, including voice calls and dial-up Internet service. The Ethernet interface is for connecting to a network, such as a local area network or the Internet. In case of connecting to the Internet, the Ethernet is for connecting to a broadband connection, such as a DSL telephone line through a DSL modem, or a coaxial cable through a cable modem. The keyboard and mouse ports are used only when the cover is opened and the unit is being serviced by a technician.

A block diagram of the system is shown in FIG. 6. Memory 37 is attached to the memory slot, hard disk 39 and CD drive 40 are connected to the IDE connector, LCD panel 46 is connected to the video connector, touch panel 47 is connected to a corn port or a USB port, printer 23 is connected to the parallel port or a USB port, CCD camera 18 is connected to a USB port or a video-in port, card reader 21 is connected to a com port or USB port, a speaker 61 is connected to the speaker out connector, and handset 13 is connected to the speaker out connector and the microphone connector.

The hard disk is pre-loaded with an operating system, such as Microsoft Windows, and all the drivers for the connected peripherals. A CD drive connected to the single board computer enables the operator to load any application software for using the built-in features on the single board computer and the connected peripherals to perform a variety of communication, information retrieval, and financial functions. Alternatively, application software may also be pre-loaded and the CD drive may be eliminated. The application software must provide on-screen menus and buttons for the user to make selections since the system has no externally accessible keyboard or mouse. Due to the absence of mechanical buttons that provide tactile and audio feedback, the application software is preferably arranged to provide audio feedback for item selection.

The rugged and compact system is adapted for use in public and hostile environments where tools, appliances, and property generally are subject to abuse and vandalism, such as the arraignment facilities in police departments, jails, prisons, juvenile detention facilities, remote public parks and beaches, public transportation kiosks, and the like. For such applications, the system may be loaded with suitable software and connected to remote servers that provide information on attorneys, bail bond services, and paralegal services. Internet access and telephone service may also be provided. Telephone functions may be provided with suitable telecommunications software using the full-duplex modem. Fees may be collected through the card reader for vending the services. Video or still images of the user may be captured with the camera and stored locally on the hard disk, or uploaded to a remote server. The use of the system, such as the information accessed and the services used, may be recorded and stored on the hard disk or uploaded to the remote service for record keeping.

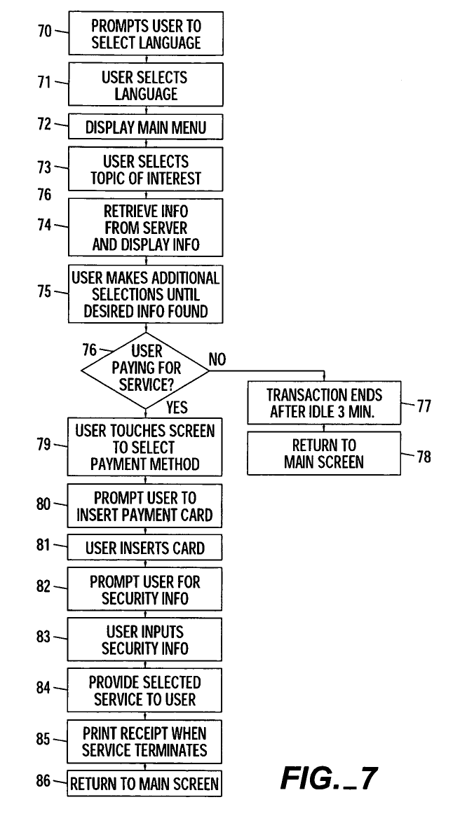

A block diagram depicting an exemplary use of the system is shown in FIG. 7. The user is prompted to select the language at block 70. After the language is selected at block 71, the main menu is displayed at block 72. A topic or item of interest on the menu is selected by the user at block 73. The corresponding information for the selected item is retrieved from a remote network server, such as Web based information, and displayed at block 74. The user may select other items on submenus or Web pages until the desired information is found at block 75.

Payment for and/or authorization to use the system services is made at block 76. If not authorization or payment is made, the transaction is terminated after a period of idle time at block 77, and the system is returned to the main screen at block 78. If the user has selected a service which requires a fee or is provided only to certain pre-selected authorized users, a payment and/or authorization screen is displayed. The payment method is selected by the user at block 79, and the user is prompted to insert a payment card at block 80, such as a credit card, ATM card, or smart card. The card is inserted at block 81. The user is prompted for security information at block 82, such as a PIN number or password. The security information is entered at block 83. Alternatively, authorization for use of the system may be made biometrically through a biometric verification system driven by appropriate software, such as a fingerprint or retinal verification, or a facial recognition system. In this respect, for a facial recognition system, it is to be understood that CCD camera 18 is in electronic communication with single board computer 36, which either itself is loaded with commercial facial recognition software, such as FACEIT®D by Visionics Corporation, or which is in network communication with a computer having such software. If a fingerprint verification system is employed, then a reader such as the Precise 100AX fingerprint reader by Precise Biometrics of Lund, Sweden, can be co-located with the card reader or positioned elsewhere, and the system will be provided with appropriate fingerprint scanning software. The same is true for a retinal verification system.

Once the user has been authorized and/or paid for the selected service, the selected service is provided to the user at block 84, and a receipt is printed for the user at block 85 at the end of the service. The system is returned to the main screen at block 86.

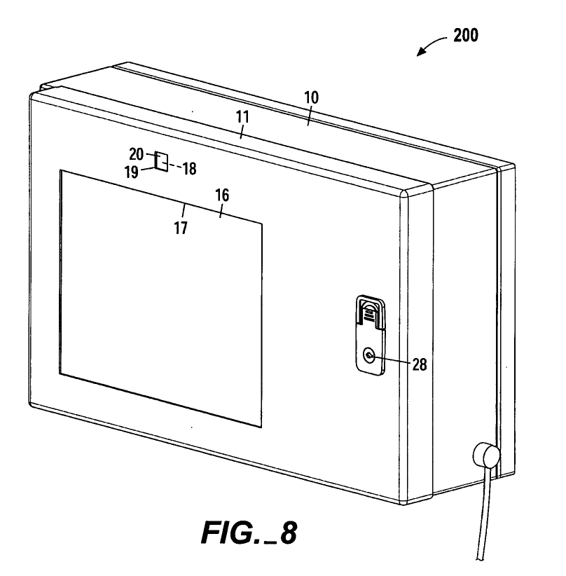

A second preferred embodiment of the inventive wall-mounted touch screen information system is shown in FIG. 8, and generally denominated 200 herein. In this embodiment, the handset, card reader, and printer are removed, as these are increasingly unnecessary elements for Internet-connected systems and user-authorized systems employing biometric verification means. In some circumstances, such as in the prison setting where prisoners frequently seek information relating to their own legal defense, a smart card reader could be physically incorporated into the housing, or connected peripherally, so that the inmate could enter a prisoner identification card. Preferably the system computer would be in electronic communication with a server, such that when any services requiring payment were rendered, costs could be automatically deducted from the prisoner's canteen account and/or the smart card updated accordingly.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. It will also be evident to one having skill in the art that the system described and disclosed herein need not be installed on a wall, but it is, rather, perfectly adapted for use on any surface, such as a table top, a transportable cart, a free-standing pedestal, and the like.

Therefore, the above description and illustrations should not be construed as limiting the scope of the invention, which is defined by the appended claims.

What is claimed as invention is:

1. A touch screen information system, comprising:
a vandal resistant housing for installation on a mounting wall;
a vandal resistant front cover hinged to a front edge of said housing;
a touch screen attached to a rear surface of said front cover behind a screen opening, wherein said touch screen is comprised of an LCD panel positioned behind a vandal resistant transparent touch panel;
a camera attached to said rear surface of said front cover behind a camera opening and generally centered above said touch screen for a direct view of a user standing before said touch screen;
a single board personal computer positioned inside said housing and connected to said touch screen, and said camera, wherein said single board computer includes a CPU, a memory slot with a memory module, an IDE controller, a video controller, at least one connection port for connection to peripheral devices, and network connection means for connecting to a network; and
a hard disk, a power supply, and a power switch positioned inside said housing and connected to said single board computer, wherein said hard disk, and all connectors on said single board computer inside said housing are inaccessible when said front cover is closed, and only said touch screen is accessible when said front cover is closed.

2. The touch screen information system of claim 1, further including an audio controller, wherein said at least one device connection means is a USB port.

3. The touch screen information system of claim 1, wherein said network connection means is selected from the group consisting of an Ethernet interface and a full-duplex fax/modem.

4. The touch screen information system of claim 1, further including a parallel port.

5. The touch screen information system of claim 1, further including a keyboard port, a mouse port, a microphone-in connector, and a speaker-out connector.

6. The touch screen information system of claim 1, further including a card reader comprised of a combined magnetic card and smart card reader capable of reading magnetic strip cards and smart cards with embedded microprocessors.

7. The touch screen information system of claim 6, wherein said card reader is installed in said housing and attached to the rear surface of said front cover.

8. The touch screen information system of claim 6, wherein said card reader is a peripheral device physically separated from said housing and electronically connected to said single board computer through a cable.

8. The touch screen information system of claim 6, further including a floppy disk drive, wherein said floppy drive, said hard disk, and all connectors on said single board computer inside said housing are inaccessible when said front cover is closed, and only said touch screen, and said card reader are accessible when said front cover is closed.

9. The touch screen information system of claim 1, further including software loaded on said hard disk to provide an interface entirely driven by a menu and input buttons on said touch screen.

10. The touch screen information system of claim 1, further including a biometric verification device selected from the group consisting of fingerprint reader, retina reader, and facial recognition system, said biometric verification device in electronic communication with a computer having biometric verification software supporting said biometric verification device.

11. The touch screen information system of claim 1, wherein the system is wall-mounted.

12. The touch screen information system of claim 1, wherein the system is adapted for use on a horizontal flat surface.
